(19) United States
(12) Patent Application Publication
(10) Pub. No.: US 2006/0245509 A1
(43) Pub. Date: Nov. 2, 2006

(54) Method and system for processing MIMO pilot signals in an orthogonal frequency division multiplexing network

(75) Inventors: Farooq Khan, Allen, TX (US); Yinong Ding, Plano, TX (US); Cornelius van Rensburg, Dallas, TX (US)

Correspondence Address: DOCKET CLERK, P.O. DRAWER 800889, DALLAS, TX, 75380, US

(73) Assignee: SAMSUNG ELECTRONICS CO., LTD, Suwon-city (KR)

(21) Appl. No.: 11/327,755

(22) Filed: Jan. 6, 2006

Related U.S. Application Data
(60) Provisional application No. 60/675,180, filed on Apr. 27, 2005.

(51) Int. Cl. H04K 1/10

(52) U.S. Cl. 375/260

(57) ABSTRACT

A method of processing multiple-input/multiple-output pilot signals in an Orthogonal Frequency Division Multiplexing network is provided. The method includes, for each of a plurality of transmit antennas in a transmit antenna array, generating a processed pilot signal using a gain unique to the transmit antenna and transmitting the processed pilot signal.

### CROSS-REFERENCE TO RELATED APPLICATION AND CLAIM OF PRIORITY

The present invention is related to the invention disclosed in U.S. Patent Application Ser. No. 60/675,180, entitled “Mimo pilot transmission and channel estimation in a wireless communication system,” filed on Apr. 27, 2005. Patent Application Ser. No. 60/675,180 is assigned to the assignee of the present application. The subject matter disclosed in Patent Application Ser. No. 60/675,180 is hereby incorporated by reference into the present disclosure as if fully set forth herein. The present application hereby claims priority under 35 U.S.C. §119(e) to Patent Application Ser. No. 60/675,180.

### TECHNICAL FIELD OF THE INVENTION

The present disclosure relates generally to wireless communications and, more specifically, to a method and system for processing multiple-input/multiple-output (MIMO) pilot signals in an Orthogonal Frequency Division Multiplexing (OFDM) network.

### BACKGROUND OF THE INVENTION

OFDM networks that employ MIMO schemes use multiple transmit antennas and multiple receive antennas to improve the capacity and reliability of a wireless communication channel. Some form of spatial signal processing is performed on the signals received at each of the receive antennas in order to recover the transmitted data streams. For example, V-BLAST is one type of spatial signal processing that uses successive interference cancellation principles to recover the transmitted data streams. Other variants of MIMO schemes include schemes that perform some type of space-time coding across the transmit antennas (for example, D-BLAST) and also beam-forming schemes such as Spatial Division Multiple Access (SDMA).

The performance of MIMO systems is dependent on channel estimation for channels from each of the transmit antennas to each of the receive antennas. To estimate these channels, separate pilot signals are transmitted from each of the transmit antennas. Some conventional MIMO pilot signal transmission schemes provide for transmitting the pilot signals on orthogonal subcarriers from each transmit antenna. For this approach, each transmit antenna transmits a pilot signal on one of the orthogonal set of subcarriers and transmits no information on the sets of subcarriers used as pilots for other transmit antennas. This results in wasted bandwidth and a degradation in the capacity of the wireless channel.

Other conventional MIMO pilot signal transmission schemes use time-multiplexing of the pilot signals. Using this approach, the number of time slots needed for pilot signal transmission increases based on the number of transmit antennas. Therefore, this scheme also results in additional overhead and a waste of system resources. For the case of a large number of MIMO transmit antennas, a significant fraction of the bandwidth or time resource may be allocated for MIMO pilot signal transmission, leaving little or no resources for data transmission. Therefore, there is a need in the art for a MIMO pilot signal transmission scheme that is more efficient than currently-implemented schemes.

### SUMMARY OF THE INVENTION

A method for processing MIMO pilot signals in an OFDM network is provided. According to an advantageous embodiment of the present disclosure, the method includes, for each of a plurality of transmit antennas in a transmit antenna array, generating a processed pilot signal using a gain unique to the transmit antenna and transmitting the processed pilot signal.

According to another embodiment of the present disclosure, a transmitter that is capable of transmitting MIMO pilot signals in an OFDM network is provided that includes a transmit antenna array, a pilot signal generator and a multiple gain applier. The transmit antenna array comprises a plurality of transmit antennas. The pilot signal generator is operable to generate a pilot signal for each of the transmit antennas. The multiple gain applier is coupled to the transmit antenna array and to the pilot signal generator and is operable to generate, for each of the transmit antennas, a processed pilot signal based on the pilot signal using a gain unique to the transmit antenna. Each of the transmit antennas is operable to transmit the processed pilot signal generated for the transmit antenna.

According to yet another embodiment of the present disclosure, a method of processing MIMO pilot signals in an OFDM network is provided that includes, for each of a plurality of stages at each of a plurality of receive antennas, receiving an input signal. A channel estimate is generated based on the input signal. A reconstructed signal is generated based on the channel estimate. The reconstructed signal is canceled from the input signal to generate a canceled signal. The input signal for a first stage comprises a combination of processed pilot signals transmitted from a plurality of transmit antennas. Each processed pilot signal is transmitted at a different gain.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary Orthogonal Frequency Division Multiplexing (OFDM) wireless network that is capable of processing MIMO pilot signals according to an embodiment of the present disclosure;

FIG. 2 illustrates a transmitter that is capable of transmitting MIMO pilot signals and a receiver that is capable of receiving MIMO pilot signals according to an embodiment of the present disclosure;

FIG. 3 illustrates an example of MIMO pilot signal processing in the transmitter of FIG. 2 according to an embodiment of the present disclosure;

FIG. 4 is a flow diagram illustrating a method for transmitting MIMO pilot signals using the transmitter of FIG. 2 according to an embodiment of the present disclosure;

FIG. 5 illustrates an example of MIMO pilot signal processing in the receiver of FIG. 2 according to an embodiment of the present disclosure;

FIG. 6 is a flow diagram illustrating a method for receiving MIMO pilot signals using the receiver of FIG. 2 according to an embodiment of the present disclosure; and

FIG. 7 illustrates a synchronization scheme according to an embodiment of the present disclosure.

### DETAILED DESCRIPTION OF THE INVENTION

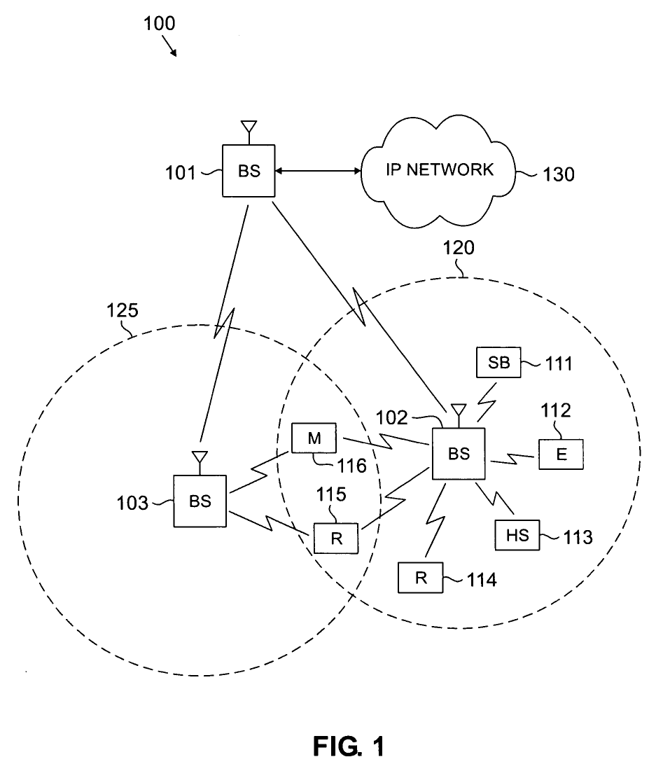

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

FIG. 1 illustrates an exemplary Orthogonal Frequency Division Multiplexing (OFDM) wireless network 100 that is capable of processing multiple-input/multiple-output (MIMO) pilot signals according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in soft handoff, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight with base station 102 and base station 103. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

In accordance with an embodiment of the present disclosure, each base station 101-103 is operable to implement a MIMO pilot signal transmission scheme in which the pilot signals from multiple transmit antennas are transmitted substantially simultaneously in parallel with a preamble using different gains. For one embodiment, the preamble is used for synchronization and channel estimation and is transmitted from each antenna during a first OFDM symbol duration within a Transmission Time Interval (TTI).

Different power levels are used for pilot signal transmission from different MIMO transmit antennas. These power levels may be configured in order to make the interference cancellation more effective at the receiver. For example, the pilot signal that is decoded first may be transmitted at a relatively high power level because this pilot signal includes interference from all the remaining pilot signals.

Each subscriber station 111-116 or other receiver, such as another base station 101-103, is operable to perform interference cancellation to recover the MIMO pilot signals transmitted by the base station 101-103. The signal from a first antenna is detected and interference cancellation is performed in order to remove the detected signal before the signal from a second antenna is detected, and so on. Thus, at each stage of interference cancellation, the previously detected pilot signal is cancelled from the received signal before performing the next antenna pilot signal detection. This process is performed on each receive antenna independently.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from about 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively, In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. The servers, Internet gateway, and public switched telephone network gateway are not shown in FIG. 1. In another embodiment, the connection to network 130 may be provided by different network nodes and equipment.

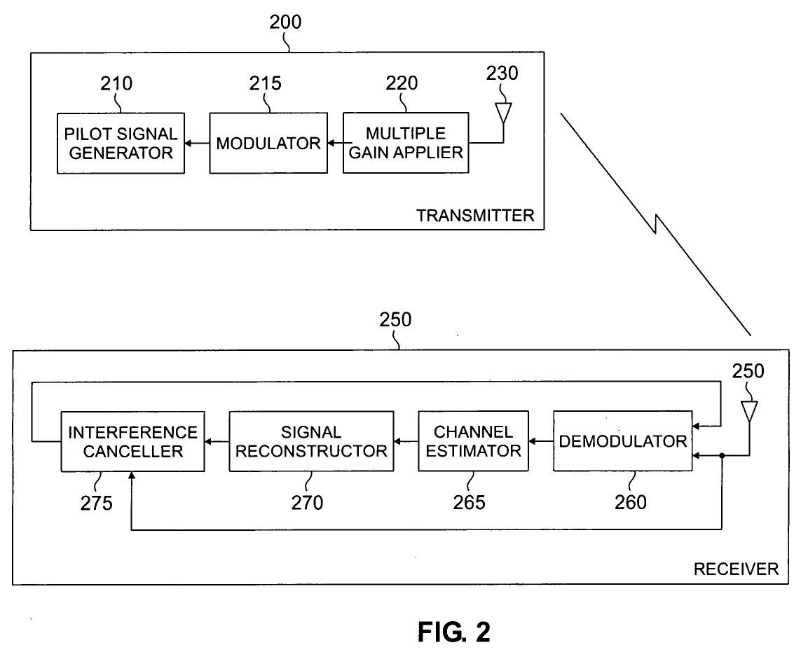

FIG. 2 illustrates a transmitter 200 that is capable of transmitting MIMO pilot signals and a receiver 205 that is capable of receiving MIMO pilot signals according to an embodiment of the present disclosure. Transmitter 200 comprises a pilot signal generator 210, a modulator 215, a multiple gain applier 220 and a transmit antenna array 230. Receiver 205 comprises a receive antenna array 250, a demodulator 260, a channel estimator 265, a signal reconstructor 270 and an interference canceller 275.

Transmit antenna array 230 comprises a plurality of transmit antennas and receive antenna array 250 may comprise a plurality of receive antennas. Each transmit antenna is operable to transmit a pilot signal corresponding to that transmit antenna for use by receiver 205 in estimating the channels between that transmit antenna and each receive antenna. Receiver 205 is operable to estimate the channels based on a comparison between the pilot signals transmitted by transmitter 200, which are known by receiver 205, and the pilot signals actually received at receiver 205. Using the channel estimates, receiver 205 may then properly decode data transmissions received from transmitter 200.

Although illustrated and described as three separate components, it will be understood that any two or more of pilot signal generator 210, modulator 215 and multiple gain applier 220 may be implemented together in a single component without departing from the scope of the present disclosure.

For one embodiment, pilot signal generator 210 is operable to generate a pilot signal for each transmit antenna of transmit antenna array 230 and to provide the pilot signals to modulator 215. Modulator 215 is coupled to pilot signal generator 210 and is operable to spread each of the pilot signals by a different pseudorandom noise (PN) code to generate a modulated pilot signal.

For a particular embodiment, modulator 215 is operable to spread the pilot signals by orthogonal codes, such as Walsh codes, before spreading the pilot signals by the PN codes. For this embodiment, modulator 215 may be operable to spread the pilot signals using a common PN code for each transmit antenna due to the pre-spreading by orthogonal codes. Also for this embodiment, modulator 215 may comprise two components: one modulator for pre-spreading the signals with orthogonal codes and one modulator for spreading the signals with a PN code. Alternatively, modulator 215 may comprise a single component for performing both operations.

Modulator 215 is operable to provide the modulated pilot signals to multiple gain applier 220. Multiple gain applier 220 is coupled to modulator 215 and is operable to apply a plurality of gains, with a different gain for each modulated pilot signal intended for a different transmit antenna. Multiple gain applier 220 is also operable to provide the modulated pilot signals with different gains to their respective transmit antennas in transmit antenna array 230 for transmission to receiver 205.

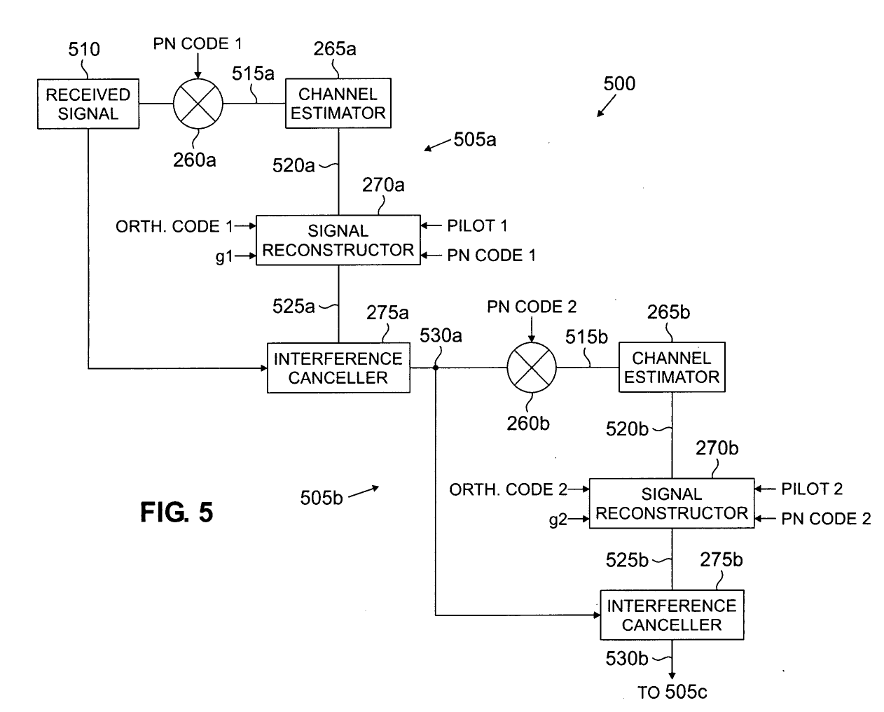

The gains correspond to an order in which receiver 205 will process the received signals, with the highest gain signals being processed first and the lowest gain signals being processed last, as described in more detail below in connection with FIG. 5. For example, multiple gain applier 220 may apply a power of 4 Watts for a first transmit antenna, a power of 2 Watts for a second transmit antenna, and a power of 1 Watt for a third transmit antenna. For this example, receiver 205 would process the signal for the first antenna first, followed by the signal for the second antenna, followed by the signal for the third antenna.

For one embodiment, the pilot signals are transmitted in parallel with each other and with the preamble used for synchronization during a first OFDM symbol duration within a TTI, leaving the remaining OFDM symbol durations available for transmitting OFDM symbols. However, it will be understood that the pilot signals may be transmitted in parallel with each other in any OFDM symbol duration other than the first duration within each TTI.

Although illustrated and described as four separate components, it will be understood that any two or more of demodulator 260, channel estimator 265, signal reconstructor 270 and interference canceller 275 may be implemented together in a single component without departing from the scope of the present disclosure.

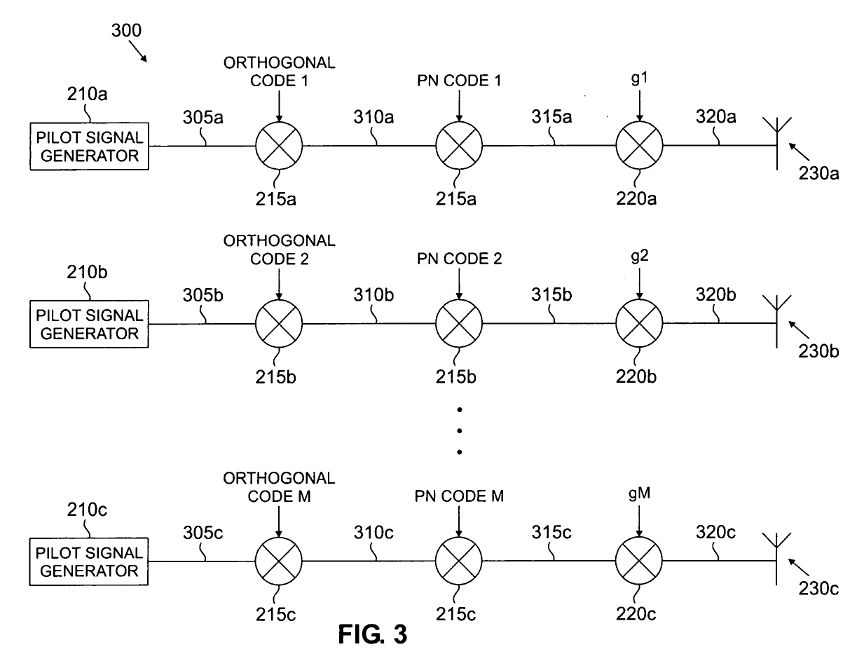

Demodulator 260 is operable to receive signals from receive antenna array 250 and, as described in more detail below, from interference canceller 275. Demodulator 260 is operable to correlate, or demodulate, the received signals using a PN code associated with the stage receiver 205 is currently processing, as described in more detail below in connection with FIG. 3. For a first stage, a first PN code is used, for a second stage, a second PN code is used, and so on. After correlating a signal with a PN code for each stage, demodulator 260 is operable to provide the correlated signal to channel estimator 265. It will be understood that, for the embodiment in which modulator 215 is operable to pre-spread the pilot signals using orthogonal codes, demodulator 260 is operable to demodulate the received signals using a common PN code.

Channel estimator 265 is coupled to demodulator 260 and is operable to estimate the channel for each combination of a transmit antenna and a receive antenna based on the correlated signals received from demodulator 260. After estimating a channel, channel estimator 265 is operable to provide the channel estimate to signal reconstructor 270. For OFDM network 100 or frequency-domain equalization systems, channel estimates in the frequency domain are used. For these systems, channel estimator 265 may obtain the frequency-domain channel estimates for the transmit antennas in transmit antenna array 230 by taking the Fast Fourier Transform of the time-domain channel estimates.

Signal reconstructor 270 is coupled to channel estimator 265 and is operable to reconstruct a signal based on the channel estimate received from channel estimator 265. As described in more detail below, signal reconstructor 270 is operable to reconstruct a signal corresponding to a different transmit antenna for each stage. Thus, for example, in a first stage, signal reconstructor 270 is operable to reconstruct the signal received from a first transmit antenna. Signal reconstructor 270 is also operable to provide each reconstructed signal to interference canceller 275.

Interference canceller 275 is coupled to signal reconstructor 270 and is operable to cancel the reconstructed signal received from signal reconstructor 270 from the received signal. Initially, interference canceller 275 is operable to cancel the first reconstructed signal from the originally received signal to generate an interference-canceled signal. Thereafter, interference canceller 275 is operable to cancel each reconstructed signal from the previously generated interference-canceled signal to generate a subsequent interference-canceled signal. Interference canceller 275 is also operable to provide each interference-canceled signal to demodulator 260 for use in a subsequent stage.

FIG. 3 illustrates an example of MIMO pilot signal processing in transmitter 200 according to an embodiment of the present disclosure. As described above in connection with FIG. 2, pilot signal generator 210 generates a pilot signal 305a-c for each transmit antenna 230a-c of transmit antenna array 230.

Although the illustrated embodiment shows pilot signal generator 210 generating three pilot signals 305a-c, it will be understood that pilot signal generator 210 may generate any suitable number of pilot signals 305 without departing from the scope of the present disclosure. In addition, it will be understood that the components 210, 215 and 220 are each labeled as multiple components, with at least one for each transmit antenna 230a-c, for illustration purposes and that a single pilot signal generator 210, modulator 215 and/or multiple gain applier 220 may perform the described operations for each transmit antenna 230a, 230b and 230c in transmit antenna array 230.

Each pilot signal 305 is provided to modulator 215, which may pre-spread the pilot signal 305 using an orthogonal code, such as a Walsh code, to generate a pre-spread pilot signal 310. Modulator 215 spreads each of the pilot signals 305 or, if available, each of the pre-spread pilot signals 310 using PN codes to generate a modulated pilot signal 315. For the embodiment in which modulator 215 spreads pilot signals 305, as opposed to pre-spread pilot signals 310, modulator 215 uses a different PN code to spread each pilot signal 305 for each transmit antenna 230. However, for the embodiment in which modulator 215 spreads pre-spread pilot signals 310, modulator 215 may use a common PN code to spread each pre-spread pilot signal 310 for each transmit antenna 230. Thus, for this embodiment, it will be understood that PN code 1, PN code 2, and so on through PN code M are the same PN code.

Modulator 215 is also operable to provide the modulated pilot signals 315 to multiple gain applier 220. Multiple gain applier 220 is coupled to modulator 215 and is operable to apply a plurality of gains, with a different gain for each modulated pilot signal 315, to generate a plurality of processed pilot signals 320 intended for different transmit antennas 230a-c. Multiple gain applier 220 is also operable to provide the processed pilot signals 320 to their respective transmit antennas in transmit antenna array 230 for transmission to receiver 205.

For one embodiment, the processed pilot signals 320 are transmitted in parallel with each other and with the preamble used for synchronization during a first OFDM symbol duration within a TTI, leaving the remaining OFDM symbol durations available for transmitting OFDM symbols. However, it will be understood that the pilot signals may be transmitted in parallel with each other in any OFDM symbol duration other than the first duration within each TTI or in any other suitable manner.

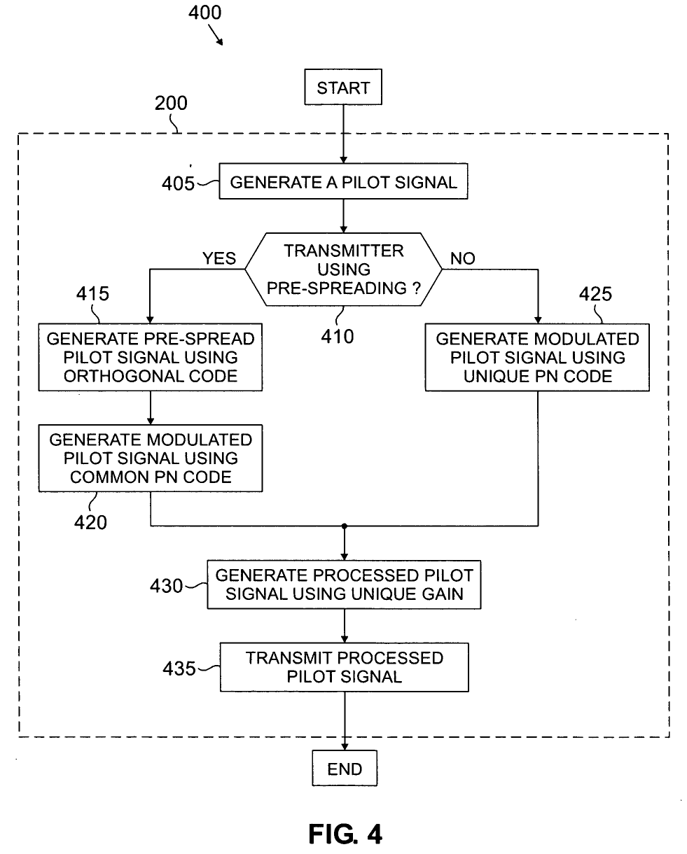

FIG. 4 is a flow diagram illustrating a method 400 for transmitting MIMO pilot signals using transmitter 200 according to an embodiment of the present disclosure. Although the method is described with respect to a single transmit antenna in transmit antenna array 230, it will be understood that the method is performed for each transmit antenna in antenna array 230. Initially, pilot signal generator 210 generates a pilot signal 305 for a particular transmit antenna (process step 405).

If transmitter 200 is using pre-spreading (process step 410), modulator 215 pre-spreads the pilot signal 305 using an orthogonal code to generate a pre-spread pilot signal 310 (process step 415). For this embodiment, modulator 215 then spreads the pre-spread pilot signal 310 using a common PN code to generate a modulated pilot signal 315 (process step 420). The common PN code is a same PN code used for each transmit antenna in transmit antenna array 230. However, if transmitter 200 is not using pre-spreading (process step 410), modulator 215 spreads the pilot signal 305 using a PN code unique to the transmit antenna to generate a modulated pilot signal 315 (process step 425).

Multiple gain applier 220 then applies a gain that is unique to the transmit antenna to the modulated pilot signal 315 in order to generate a processed pilot signal 320 (process step 430). The transmit antenna then transmits the processed pilot signal 320 to receiver 205 (process step 435).

FIG. 5 illustrates an example of MIMO pilot signal processing 500 in receiver 205 according to an embodiment of the present disclosure. For simplicity, the example illustrated in FIG. 5 shows only two stages 505a-b of MIMO pilot signal processing 500, with an indication of a third stage 505c that is not illustrated. However, as described below, it will be understood that the number of stages 505 in MIMO pilot signal processing 500 corresponds to the number of transmit antennas in transmit antenna array 230.

In addition, the MIMO pilot signal processing 500 is described with respect to a single receive antenna in receive antenna array 250. Thus, it will be understood that each of the receive antennas performs MIMO pilot signal processing 500 independently. Furthermore, it will be understood that the components 260, 265, 270 and 275 are each labeled as multiple components, with one for each stage 505, for illustration purposes and that a single demodulator 260, channel estimator 265, signal reconstructor 270 and/or interference canceller 275 may perform the described operations for each stage 505.

As described above in connection with FIG. 2, each receive antenna in receive antenna array 250 receives the processed pilot signals 320 transmitted from each transmit antenna in transmit antenna array 230. Thus, for each receive antenna, a received signal 510 comprises the combined processed pilot signals 320 transmitted by transmit antenna array 230 of transmitter 200.

For the first stage 505a, the received signal 510 is provided to demodulator 260a, which demodulates the received signal 510 using PN code 1 to generate an estimation signal 515a. PN code 1 corresponds to PN code 1 used by modulator 215 of transmitter 200 to generate processed pilot signal 320a. Channel estimator 265a then generates a channel estimate 520a for transmit antenna 230a based on the estimation signal 515a and provides the channel estimate 520a to signal reconstructor 270a.

Using the known pilot signal 305a, orthogonal code 1 (if used by transmitter 200), PN code 1, and gain g1, signal reconstructor 270a generates a reconstructed signal 525a based on the channel estimate 520a that corresponds to the processed pilot signal 320a transmitted by transmit antenna 230a and provides the reconstructed signal 525a to interference canceller 275a. Interference canceller 275a also receives the received signal 510. Interference canceller 275a is then able to cancel the reconstructed signal 525a from the received signal 510 in order to generate a canceled signal 530a. Therefore, canceled signal 530a comprises the combined processed pilot signals 320 transmitted by each of the transmit antennas of transmit antenna array 230 except for transmit antenna 230a.

Interference canceller 275a provides canceled signal 530a as an input to the second stage 505b. Thus, at the second stage 505b, the input signal 530a comprises essentially no interference from the processed pilot signal 320a transmitted by transmit antenna 230a.

The input signal for the second stage 505b, which is the canceled signal 530a, is provided to demodulator 260b, which demodulates the canceled signal 530a using PN code 2 to generate an estimation signal 515b. PN code 2 corresponds to PN code 2 used by modulator 215 of transmitter 200 to generate processed pilot signal 320b. Channel estimator 265b then generates a channel estimate 520b for transmit antenna 230b based on the estimation signal 515b and provides the channel estimate 520b to signal reconstructor 270b.

Using the known pilot signal 305b, orthogonal code 2 (if used by transmitter 200), PN code 2, and gain g2, signal reconstructor 270b generates a reconstructed signal 525b based on the channel estimate 520b that corresponds to the processed pilot signal 320b transmitted by transmit antenna 230b and provides the reconstructed signal 525b to interference canceller 275b. Interference canceller 275b also receives the canceled signal 530a. Interference canceller 275b is then able to cancel the reconstructed signal 525b from the canceled signal 530a in order to generate a canceled signal 530b. Therefore, canceled signal 530b comprises the combined processed pilot signals 320 transmitted by each of the transmit antennas of transmit antenna array 230 except for transmit antenna 230a and transmit antenna 230b.

Interference canceller 275b provides canceled signal 530b as an input to the third stage 505c. Thus, at the third stage 505c, the input signal 530b comprises essentially no interference from the processed pilot signals 320a and 320b transmitted by transmit antennas 230a and 230b.

By using a number of stages 505 corresponding to the number of transmit antennas 230a-c, MIMO pilot signal processing 500 allows channel estimator 265 to generate channel estimates 520 for each communication channel for a particular receive antenna in receive antenna array 250. In addition, by estimating the channel for the processed pilot signal 320 with the highest gain in each stage 505, channel estimator 265 is able to obtain reliable estimates and, by canceling the reconstructed signal 525 with the highest gain in each stage 505, channel estimator 265 is able to estimate subsequent channels more and more reliably because of reduced interference that improves the signal-to-interference-plus-noise ratio (SINR).

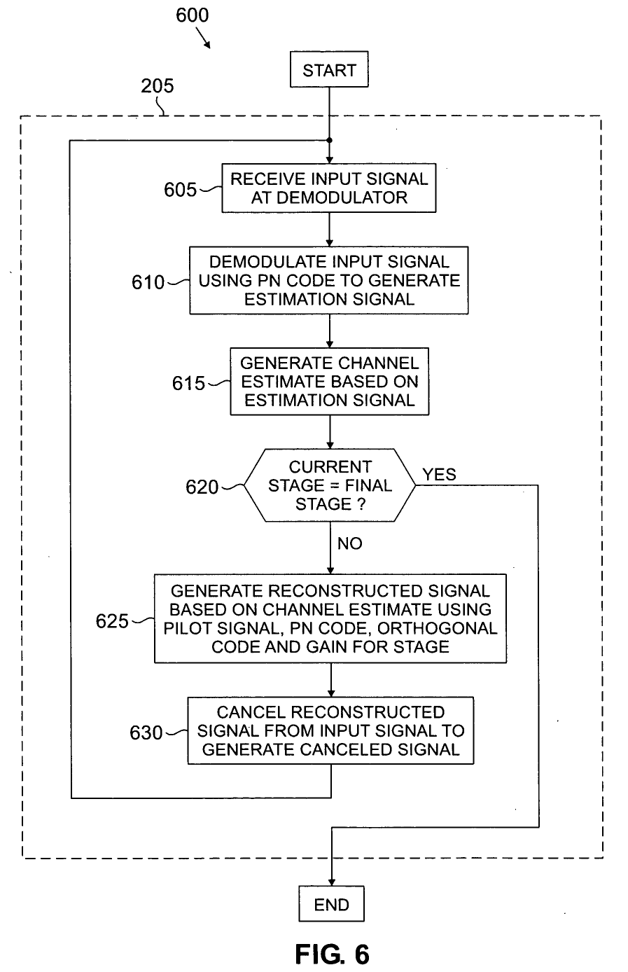

FIG. 6 is a flow diagram illustrating a method 600 for receiving MIMO pilot signals using receiver 205 according to an embodiment of the present disclosure. Although the method is described with respect to a single receive antenna in receive antenna array 250, it will be understood that the method is performed for each receive antenna in antenna array 250.

Initially, an input signal is received at demodulator 260 (process step 605). For the first stage 505a, the input signal comprises the received signal 510, which is a combination of each of the processed pilot signals 320 transmitted from transmit array 250 and received at the receive antenna.

Demodulator 260 demodulates the input signal with a PN code associated with the current stage 505 to generate an estimation signal 515 (process step 610). For the first stage 505a, for example, the associated PN code is PN code 1. However, for the embodiment in which transmitter 200 uses pre-spreading, the PN code may be a common PN code that is the same for each stage 505. Based on the estimation signal 515, channel estimator 265 generates a channel estimate 520 for the channel between the transmit antenna corresponding to the current stage 505 and the receive antenna (process step 615).

If the current stage 505 is the final stage 505 (process step 620), each channel has been estimated and the method comes to an end at this point. However, if the current stage 505 is not the final stage 505 (process step 620), the method continues.

Using the known pilot signal 305, the PN code for the stage 505, any orthogonal code associated with the stage 505 that may have been used by transmitter 200, and a gain associated with the stage 505, signal reconstructor 270 generates a reconstructed signal 525 based on the channel estimate 520 (process step 625). The reconstructed signal 525 corresponds to the processed pilot signal 320 transmitted by the transmit antenna associated with the stage 505. Interference canceller 275 cancels the reconstructed signal 525 from the input signal to generate a canceled signal 530 (process step 630).

The method then returns to process step 605, where demodulator 260 receives the input signal for a subsequent stage 505. The input signal for each subsequent stage 505 after the first stage 505a comprises the canceled signal 530 generated by interference canceller 275 in the immediately previous stage 505.

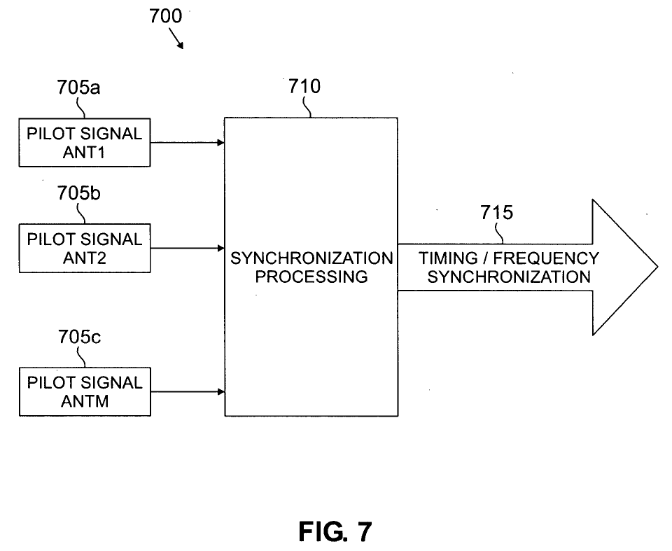

FIG. 7 illustrates a synchronization scheme 700 according to an embodiment of the present disclosure. For this embodiment, pilot signals 705a-c from a plurality of transmit antennas (ANT1-ANTM) are used by synchronization processing 710 to provide timing and frequency synchronization 715. By using multiple pilot signals 705a-c for synchronization, the accuracy and speed of timing and frequency synchronization 715 provided by synchronization processing 710 is improved. For one embodiment, the pilot signals 705a-c may correspond to the processed pilot signals 320a-c generated by transmitter 200.

While several embodiments have been provided in the present disclosure, it should be understood that the disclosed systems and methods may be embodied in many other specific forms without departing from the spirit or scope of the present disclosure. The exemplary embodiments disclosed are to be considered as illustrative and not restrictive, and the intention is not to be limited to the details given herein. It is intended that the disclosure encompass all alternate forms within the scope of the appended claims along with their full scope of equivalents.

What is claimed is:

1. A method of processing multiple-input/multiple-output (MIMO) pilot signals in an Orthogonal Frequency Division Multiplexing (OFDM) network, comprising, for each of a plurality of transmit antennas in a transmit antenna array:
generating a processed pilot signal using a gain unique to the transmit antenna; and
transmitting the processed pilot signal.

2. The method as set forth in claim 1, further comprising:
generating a pilot signal;
generating a modulated pilot signal based on the pilot signal using a pseudorandom noise (PN) code; and
generating the processed pilot signal comprising generating the processed pilot signal based on the modulated pilot signal.

3. The method as set forth in claim 2, further comprising:
generating a pre-spread pilot signal based on the pilot signal using an orthogonal code; and
generating the modulated pilot signal comprising generating the modulated pilot signal based on the pre-spread pilot signal using a common PN code.

4. The method as set forth in claim 3, the orthogonal code comprising a Walsh code.

5. The method as set forth in claim 2, generating the modulated pilot signal comprising generating the modulated pilot signal using a PN code unique to the transmit antenna.

6. The method as set forth in claim 1, transmitting the processed pilot signal comprising transmitting the processed pilot signal during a first OFDM symbol duration within each of a plurality of Transmission Time Intervals.

7. A transmitter capable of transmitting MIMO pilot signals in an OFDM network, comprising:
a transmit antenna array comprising a plurality of transmit antennas;
a pilot signal generator operable to generate a pilot signal for each of the transmit antennas; and
a multiple gain applier coupled to the transmit antenna array and to the pilot signal generator, the multiple gain applier operable to generate, for each of the transmit antennas, a processed pilot signal based on the pilot signal using a gain unique to the transmit antenna, each of the transmit antennas operable to transmit the processed pilot signal generated for the transmit antenna.

8. The transmitter as set forth in claim 7, further comprising a modulator coupled to the pilot signal generator and to the multiple gain applier, the modulator operable to generate, for each of the transmit antennas, a modulated pilot signal based on the pilot signal using a pseudorandom noise (PN) code, the multiple gain applier operable to generate the processed pilot signal based on the modulated pilot signal.

9. The transmitter as set forth in claim 8, the modulator further operable to generate a pre-spread pilot signal based on the pilot signal using an orthogonal code and to generate the modulated pilot signal based on the pre-spread pilot signal using a common PN code.

10. The transmitter as set forth in claim 9, the orthogonal code comprising a Walsh code.

11. The transmitter as set forth in claim 8, the modulator operable to generate the modulated pilot signal using a PN code unique to the transmit antenna.

12. The transmitter as set forth in claim 7, each of the transmit antennas operable to transmit the processed pilot signal during a first OFDM symbol duration within each of a plurality of Transmission Time Intervals.

13. A method of processing MIMO pilot signals in an OFDM network, comprising, for each of a plurality of stages at each of a plurality of receive antennas:
receiving an input signal;
generating a channel estimate based on the input signal;
generating a reconstructed signal based on the channel estimate; and
canceling the reconstructed signal from the input signal to generate a canceled signal, the input signal for a first stage comprising a combination of processed pilot signals transmitted from a plurality of transmit antennas, each processed pilot signal transmitted at a different gain.

14. The method as set forth in claim 13, the input signal for each subsequent stage comprising the canceled signal generated in an immediately previous stage.

15. The method as set forth in claim 13, further comprising:
demodulating the input signal using a pseudorandom noise (PN) code to generate an estimation signal; and
generating the channel estimate comprising generating the channel estimate based on the estimation signal.

16. The method as set forth in claim 15, the PN code associated with the stage.

17. The method as set forth in claim 15, the PN code comprising a common PN code.

18. The method as set forth in claim 13, generating the reconstructed signal comprising generating the reconstructed signal using a pilot signal associated with the stage, a PN code associated with the stage, and a gain associated with the stage.

19. The method as set forth in claim 13, generating the reconstructed signal comprising generating the reconstructed signal using a pilot signal associated with the stage, a common PN code, an orthogonal code associated with the stage, and a gain associated with the stage.

20. The method as set forth in claim 19, the orthogonal code comprising a Walsh code.
